(19) United States
(12) Patent Application Publication
(10) Pub. No.: US 2011/0093801 A1
(43) Pub. Date: Apr. 21, 2011

(54) APPLICATION EXTENSION SYSTEM, EXTENSION METHOD, EXTENSION PROGRAM

(76) Inventors: Kazuya Koyama, Tokyo (JP); Keiichi Iguchi, Tokyo (JP); Takatoshi Kitano, Tokyo (JP)

(21) Appl. No.: 12/999,962

(22) PCT Filed: Jun. 29, 2009
(86) PCT No.: PCT/JP2009/061891

§ 371 Date: Dec. 17, 2010

(30) Foreign Application Priority Data
Jun. 30, 2008 (JP) 2008-170297

(51) Int. Cl. G06F 3/048

(52) U.S. Cl. 715/763

(57) ABSTRACT

Provide are an application extension system, an extension method, and an extension program which can perform customize over a plurality of pages in a Web system and modify the customize method in accordance with the content of the Web pages. The application extension system includes; An interface (11) which receives registration of a process decision definition (13) containing an automatic execution start condition and an automatic execution definition (14) indicating the content of the process executed automatically; and a communication interface (12) which receives a communication message from a browser (20) or an application (30). Upon reception of a communication message from the browser (20) or the application (30), it is determined whether to execute the registered automatic execution definition (14) in accordance with the registered process decision definition (13) and the communication message is transmitted to the application (30) or the browser (20) as the destination. Moreover, at least one GUI operation instruction is transmitted to the browser (20) in accordance with the automatic execution definition (14) which has been determined to be executed.

### TECHNICAL FIELD

The present invention relates to an application extension system, an extension method, and an extension program for performing customization so as to match the needs of a user of an existing Web system mainly and particularly relates to an application extension system for customizing behavior of an application composed of a plurality of Web pages.

### BACKGROUND ART

A Web system which make a general-purpose Web browser of a client terminal perform interpretation, execution, and display of GUI (Graphical User Interface) data described by a description language such as the HTML (Hyper Text Markup Language), a script language, or the like with a protocol such as the HTTP (HyperText Transport Protocol) or the like is widely used by various information systems. A Web system which has a lot of information and functions already exists in many companies and organizations.

However, the currently used Web system is not necessarily one that matches the user' needs. In many cases, it is hard to use the system for the user. This is caused by many factors as follows: it is usually difficult to grasp the requirements needed for the system correctly and comprehensively at the time of establishing the system, the user' needs themselves change with time even when the system that matches the user's needs have been established, it is basically difficult to establish an information system that meets the needs of all users at the same time because many users have different needs from each other, or the like. In such cases, in order to make the system meet the user's needs, modification of the system itself or reconstruction of the system is simply performed.

However, in many cases, a large amount of development cost is required for such modification and reconstruction. Additionally, when a dedicated system is established for each different user, a problem in which an operation cost and a maintenance cost increase occurs.

In some system, the system itself has a customization function with which the user can change the behavior thereof. However, not all the systems have always the customization function. Even when the system has the customization function, in many cases, the function is insufficient to meet the user's needs.

In order to solve this problem, a technology in which the customization is realized by changing the HTTP and the HTML that are an input-output part of the Web system, the GUI displayed in the browser, or the like without changing the existing Web system itself has been used.

For example, a technology in which addition, modification, deletion, or the like of a GUI part that is a part of the GUI constructed by the HTML is performed by changing the HTML is used as a technology for converting a single Web page. In patent document 1, a method in which a script for changing a page is inserted in the Web page as a proxy of the HTTP and this script is executed on the Web browser to change the GUI is disclosed.

In patent document 2, a device on a terminal, which is not a general-purpose Web browser add the additional information to the Web content.

In patent document 3, a process for converting the Web screen for a mobile terminal is eased by analyzing the meaning of the page as a technology for extracting or converting a part of the GUI screen.

A technology for automatically performing an operation that is basically performed by the user on the Web page is disclosed although it is not a technology for rewriting the Web page. For example, in patent document 4, by automatically performing the Web page operation on a server, a system that outputs only the HTML used by a person can be operated by an e-mail. In patent document 5, the Web system is automatically operated for the cooperation of a client/server type system with the Web system on a client terminal.

### Related Art Document

[Patent Document]

[Patent document 1] Japanese Patent Publication No. 3396177

[Patent document 2] Japanese Patent Publication No. 3594231

[Patent document 3] Japanese Patent Application Laid-Open No. 2002-116983

[Patent document 4] Japanese Patent Application Laid-Open No. 2002-342152

[Patent document 5] Japanese Patent Application Laid-Open No. 2001-101132

### BRIEF SUMMARY OF THE INVENTION

### Problems to be Solved by the Invention

A first problem is difficulty in customization over a plurality of pages in the Web system using a screen transition over a plurality of Web pages. Here, the customization over a plurality of pages is to change a content of the customization of one page depending on the content of another page or to change a screen transition relationship between the pages.

In the technology for converting a single page, one conversion process is completed in one page. Therefore, a change in screen display in which for example, the contents of a plurality of pages are collectively displayed in one page cannot be performed. Additionally, a change in a page transition form cannot be performed. Therefore, a change to omit a part of the page transition in a work that is performed over a plurality of pages by a user and also an extraction of a function in the Web system that cannot be reached without passing through a plurality of screen transitions by a specified user operation and a synthesis thereof cannot be performed.

In a method of performing an automatic execution on the server among the technologies of the automatic execution, by automatically performing the page transition, the page transition can be shown to the user as if it is omitted. However, because an execution interpretation function such as the HTML, the script language, or the like corresponding to the Web browser that is usually on the client terminal is operated on the server, all execution states created on the browser in an operation process of the Web system such as a display of session information, a display of an additional window, or the like exist on the server. Therefore, the execution state cannot be moved to the browser on the terminal or it cannot be moved from the browser on the terminal to the server.

For this reason, in the Web system requiring such execution state in the operation, a seamless switching between an manual operation of the browser on the terminal by the user and the automatic execution in which usually, the user manually operates the Web system with the Web browser on the terminal, a part of the operation is automatically executed, and after the automatic execution is performed, the manual operation is continued again cannot be performed.

On the other hand, in a technology for performing the automatic execution on the client terminal among the technologies of the automatic execution, a determination of a content of the automatic execution and a start timing is performed by the user on the client terminal or another device on the terminal. Consequently, a service provider can not perform a control so as to perform the automatic execution to a plurality of users in the same form. Therefore, the technology cannot be used for realization of customization over a plurality of pages.

A second problem is difficulty in change of a customization method in accordance with the content of the Web page.

In the above-mentioned patent document, a conversion content is fixedly determined according to a URL (Uniform Resource Locator) of a target Web page or the content is changed according to user's preference or role displayed in the Web page. Therefore, the content of customization cannot be changed in accordance with the content of the Web page that the user wants to display. Consequently, an appropriate customization cannot be performed in the Web system in which a display content is determined according to a session state and different contents are displayed by using the same URL or in a case in which the Web system itself changes the content according to a web visitor or a status. Additionally, a customization method in which based on a content of one page, a content of another page successively displayed is customized cannot be changed.

The present invention is made in view of the above problem. The object of the present invention is to provide an application extension system, an extension method, and an extension program which enables customization over a plurality of pages in the Web system using the screen transition over a plurality of Web pages and can change a customization method in accordance with the content of the Web page.

### Means for Solving the Problems

In order to achieve the above-mentioned object, the present invention provides an application extension system as a first aspect characterized in that the application extension system include's an interface for receiving registration of a process determination definition including a start condition of an automatic execution and an automatic execution definition which indicates a content of a process performed as the automatic execution and a communication interface for receiving a communication message from a browser or an application, and at the time of receiving the communication message from the browser or the application, the application extension system determines whether to execute the registered automatic execution definition according to the registered process determination definition, transmits the communication message to the application or the browser that is a destination, and sends at least one GUI operation instruction to the browser according to the automatic execution definition for which execution has been determined.

Additionally, in order to achieve the above-mentioned object, the present invention provides an application extension method as a second aspect characterized in that the application extension method includes a step of receiving registration of a process determination definition including a start condition of an automatic execution and an automatic execution definition which indicates a content of a process performed as the automatic execution, a step of receiving a communication message from a browser or an application, a step of determining whether to execute the registered automatic execution definition according to the registered process determination definition, a step of transmitting the received communication message to the application or the browser that is a destination, and a step of sending at least one GUI operation instruction to the browser according to the automatic execution definition for which execution has been determined.

In order to achieve the above-mentioned object, the present invention provides an application extension program as a third aspect characterized in that the application extension program causes a computer to perform the application extension method according to the above-mentioned second aspect.

### Effect of the Invention

By the present invention, an application extension system, an extension method, and an extension program which enables customization over a plurality of pages in the Web system using a screen transition over a plurality of Web pages and can change a customization method in accordance with a content of the Web page can be provided.

### BRIEF DESCRIPTION OF THE DRAWINGS

FIG. 1 is a figure showing a configuration of an application extension system according to the present invention.

FIG. 2 is a figure showing a configuration of an application extension system according to a first exemplary embodiment in which the present invention is preferably employed.

FIG. 3 is a figure showing a structure of an information extraction definition of an application extension system according to a first exemplary embodiment.

FIG. 4 is a figure showing a structure of a process determination definition of an application extension system according to a first exemplary embodiment.

FIG. 5 is a figure showing a structure of a conversion definition of an application extension system according to a first exemplary embodiment.

FIG. 6 is a figure showing a structure of an automatic execution definition of an application extension system according to a first exemplary embodiment.

FIG. 7 is a figure showing a structure of data managed by a data management unit of an application extension system according to a first exemplary embodiment.

FIG. 8 is a figure showing a flow of an operation of an application extension system according to a first exemplary embodiment.

FIG. 9 is a figure showing a flow of an operation of a browser control unit of an application extension system according to a first exemplary embodiment.

FIG. 10 is a figure showing a structure of data managed by a data management unit of an application extension system according to a third exemplary embodiment in which the present invention is preferably employed.

FIG. 11 is a figure showing a flow of an operation of an application extension system according to a fourth exemplary embodiment in which the present invention is preferably employed.

FIG. 12 is a figure showing a flow of an operation of a browser control unit of an application extension system according to a fourth exemplary embodiment.

FIG. 13 is a figure showing a configuration of an application extension system according to a fifth exemplary embodiment in which the present invention is preferably employed.

FIG. 14 is a figure showing a configuration of an application extension system according to a sixth exemplary embodiment in which the present invention is preferably employed.

FIG. 15 is a figure showing a structure of an information extraction definition of an application extension system according to a seventh exemplary embodiment in which the present invention is preferably employed.

FIG. 16 is a figure showing a configuration of an application extension system according to a first example.

FIG. 17 is a figure showing an operation of a Web application in a first example.

FIG. 18 is a figure showing an operation of a Web application in a first example.

FIG. 19 is a figure showing a structure of an information extraction definition in a first example.

FIG. 20 is a figure showing a structure of a process determination definition in a first example.

FIG. 21 is a figure showing a structure of a conversion definition in a first example.

FIG. 22 is a figure showing a structure of an automatic execution definition in a first example.

FIG. 23 is a figure showing a structure of data managed by a data management unit in a first example.

FIG. 24 is a figure showing an operation of an application extension system in a first example.

FIG. 25 is a figure showing a configuration of an application extension system according to a second example.

FIG. 26 is a figure showing an operation of a Web application in a second example.

FIG. 27 is a figure showing an operation of a Web application in a second example.

FIG. 28 is a figure showing an operation of a Web application in a second example.

FIG. 29 is a figure showing an operation of a Web application in a second example.

FIG. 30 is a figure showing a structure of an information extraction definition in a second example.

FIG. 31 is a figure showing a structure of a process determination definition in a second example.

FIG. 32 is a figure showing a structure of a conversion definition in a second example.

FIG. 33 is a figure showing a structure of an automatic execution definition in a second example.

FIG. 34 is a figure showing a structure of data managed by a data management unit in a second example.

FIG. 35 is a figure showing an operation of an application extension system in a second example.

### MODE FOR CARRYING OUT THE INVENTION

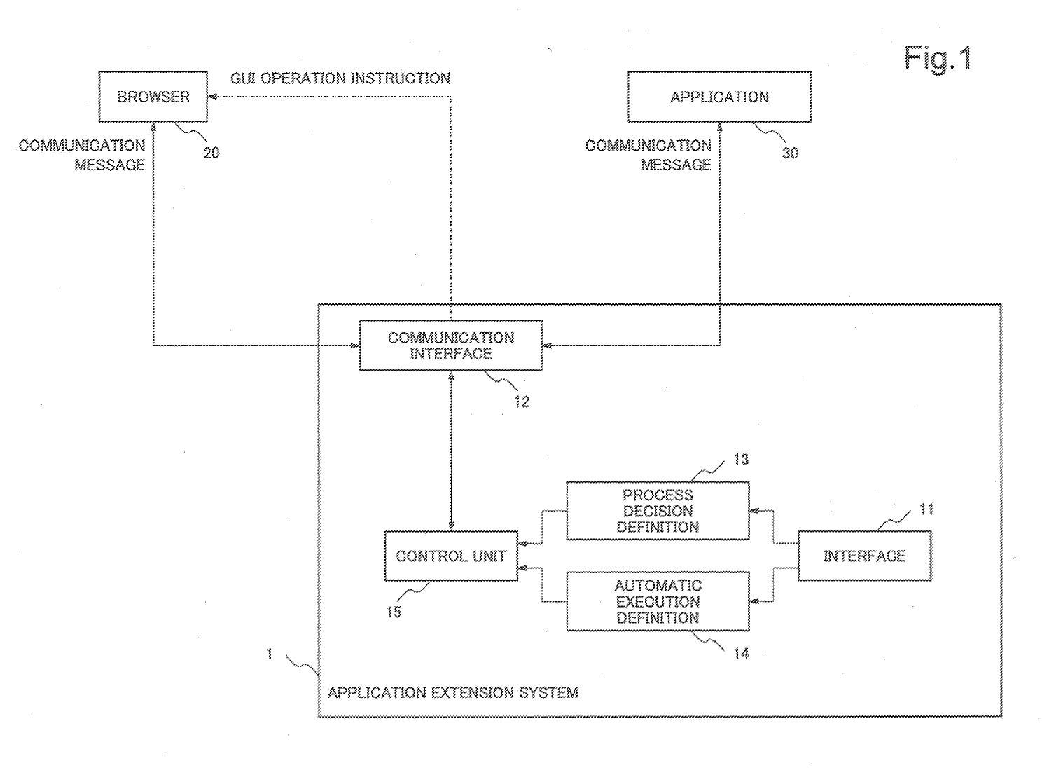

As shown in FIG. 1, an application extension system 1 according to the present invention is characterized in that the application extension system includes an interface 11 for receiving registration of a process decision definition 13 including a start condition of automatic execution and an automatic execution definition 14 which indicates a content of a process performed as the automatic execution and a communication interface 12 for receiving a communication message from a browser 20 or an application 30 and a control unit 15 determines whether to execute the registered automatic execution definition 14 according to the registered process decision definition 13 at the time of receiving the communication message from the browser 20 or the application 30, transmits the communication message to the application 30 or the browser 20 that is a destination, and sends at least one GUI operation instruction to the browser 20 according to the automatic execution definition 14 for which execution has been determined. The GUI operation instruction is an instruction with respect to an arbitrary operation on the GUI with which a value is entered in an input field of the GUI displayed in the browser 20 or a button on the GUI is pressed down.

Here, an arbitrary type of interface can be used for the interface 11. For example, it may be an interface for receiving the process decision definition 13 and the automatic execution definition 14 from an external device (not shown) or it may be an interface (user interface such as a keyboard or the like) for receiving an input operation for registering these definitions. A function of the control unit 15 can be realized by a software process by a computer.

By using such configuration, the customization over a plurality of pages in the Web system using a screen transition over a plurality of Web pages can be performed and a customization method can be changed in accordance with the content of the Web page.

The preferred exemplary embodiment of the present invention will be described below.

### First Exemplary Embodiment

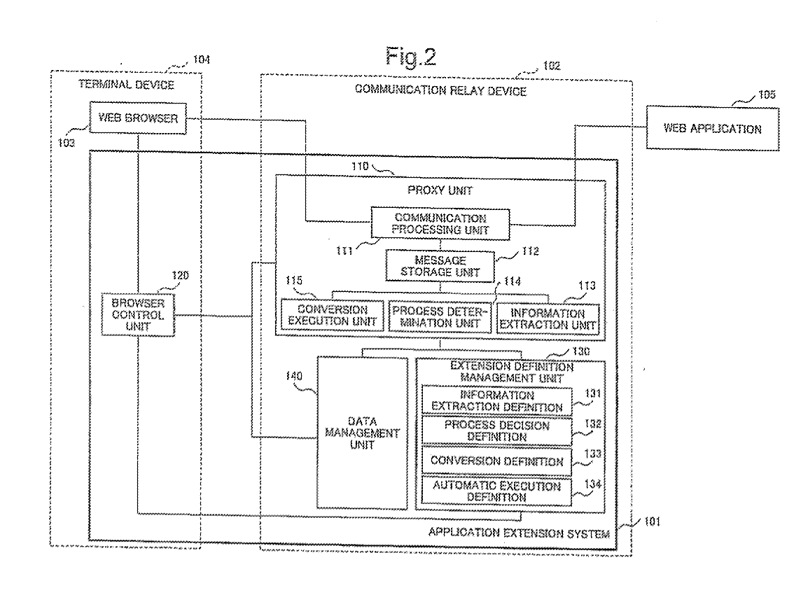

A first exemplary embodiment in which the present invention is preferably employed will be described. FIG. 2 shows a configuration of an application extension system according to the exemplary embodiment. An application extension system 101 includes a proxy unit 110, a browser control unit 120, an extension definition management unit 130, and a data management unit 140.

The proxy unit 110 includes a communication processing section 111, a message storage section 112, an information extraction section 113, a process determination section 114, and a conversion execution section 115. Further, a part of the function of the communication interface 12 and the control unit 15 shown in FIG. 1 corresponds to the communication processing section 111. A part of the function of the control unit 15 shown in FIG. 1 corresponds to the information extraction section 113. A part of the function of the control unit 15 shown in FIG. 1 corresponds to the process determination section 114. A part of the function of the control unit 15 shown in FIG. 1 corresponds to the conversion execution section 115.

The extension definition management unit 130 includes an information extraction definition 131, a process decision definition 132, a conversion definition 133, and an automatic execution definition 134.

The browser control unit 120 is arranged on a terminal device 104 that includes a Web browser 103 and connected to the Web browser 103. Further, a part of the function of the control unit 15 shown in FIG. 1 corresponds to the browser control unit 120. A section corresponding to the interface 11 shown in FIG. 1 is not shown but a communication relay device 102 may include the user interface or a configuration in which the process decision definition 132 and the automatic execution definition 134 are registered via an arbitrary external device including the terminal device 104 may be used.

The proxy unit 110, the browser control unit 120, the extension definition management unit 130, and the data management unit 140 are provided on the communication relay device 102. The communication processing section 111 is connected to the external Web browser 103 and the Web application 105. The plurality of Web browsers 103 and the plurality of web applications 105 may be used.

The function of the communication processing section 111, the information extraction section 113, and the process determination section 114 in the proxy unit 110 can be realized by the software process by the computer. The function of the browser control unit 120 can also be realized by the software process by the computer.

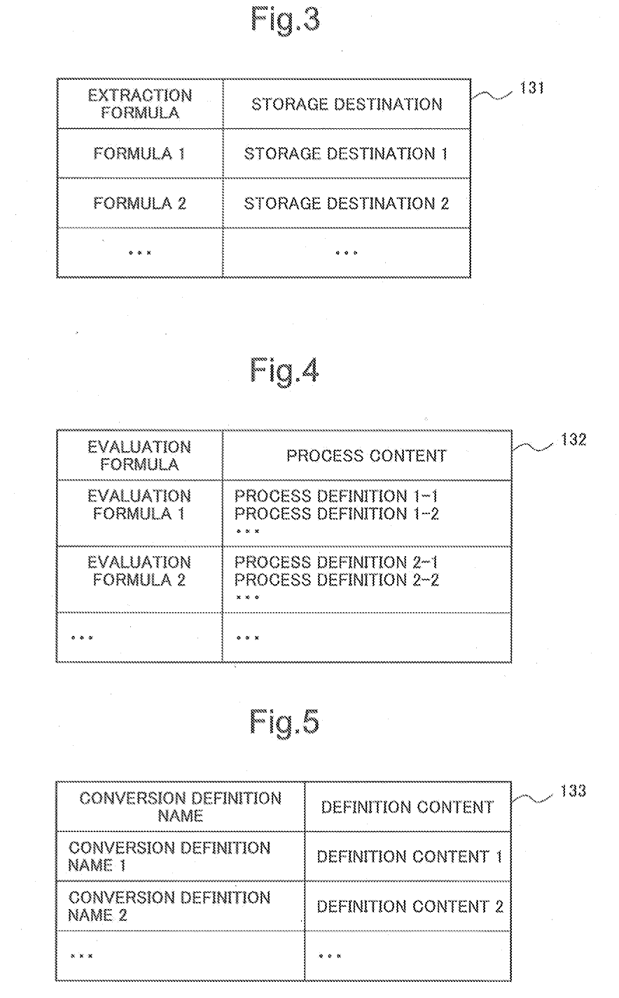

FIG. 3 shows a structure of the information extraction definition 131. The information extraction definition 131 is defined by an extraction formula and a storage destination. There are various methods for describing the extraction formula. As a preferred example, an XPath description formula to a specific header name of the HTTP protocol and an internal structure of the HTML or a calculation formula for performing a calculation of a numerical value and a character string or the like is presented. The storage destination is a name of data in the data management unit 140.

FIG. 4 shows a structure of the process decision definition 132. The process decision definition 132 is defined as a list of a data name and an operation of its value or an evaluation formula, and a definition name of the automatic execution definition 134 or the conversion definition 133 executed when the evaluation formula is satisfied. Further, the process decision definition 13 shown in FIG. 1 corresponds to the process decision definition 132.

FIG. 5 shows a structure of the conversion definition 133. The conversion definition 133 is defined as a list of a definition name (conversion definition name) and a conversion program (conversion content) for processing a header of the HTTP protocol or message data.

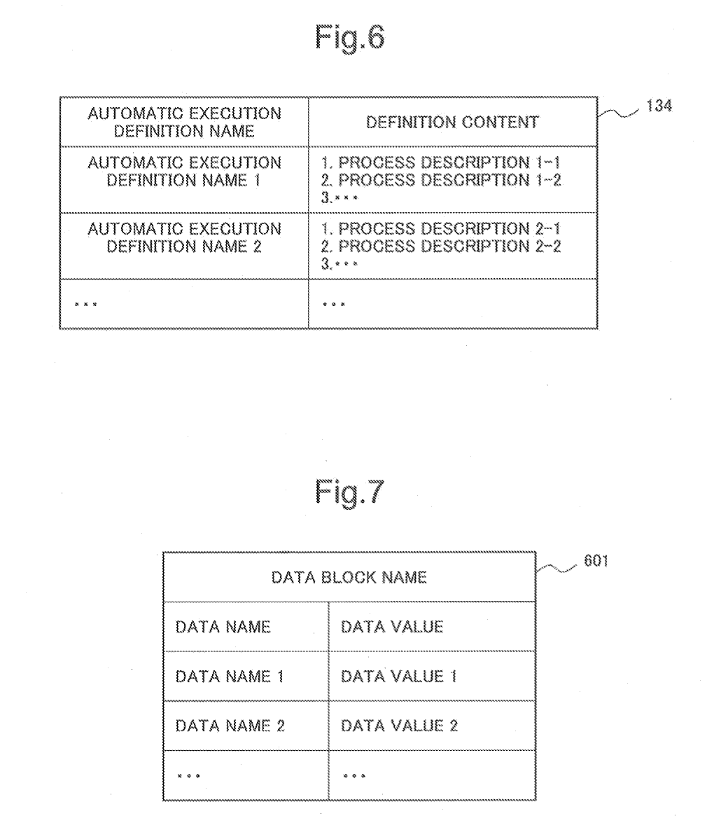

FIG. 6 shows a structure of the automatic execution definition 134. The automatic execution definition 134 is defined as a list of the definition name (automatic execution definition name) and a process description that is the definition content. Further, the automatic execution definition 14 shown in FIG. 1 corresponds to the automatic execution definition 134.

FIG. 7 shows a structure of data stored in the data management unit 140. The data management unit 140 can include a plurality of data blocks 601 and each data block 601 is defined as a list of a data name and a data value.

The publicly known technology can be applied to a method for describing the extraction formula or the operation, the evaluation formula, the conversion program, the macro description, or the like. It is not limited to a specific description method.

The operation of the application extension system 101 will be described.

The communication processing section 111 receives a request message from the Web browser 103 to the web application 105 or a response message from the web application 105 to the Web browser 103, stores those messages in the message storage section 112, and calls the information extraction section 113.

The information extraction section 113 extracts a necessary information from the request message and the response message stored in the message storage section 112 according to the information extraction definition 131 of the extension definition management unit 130, stores it in the data management unit 140, and calls the process determination section 114.

The process determination section 114 refers to the data of the data management unit 140 according to the process decision definition 132 of the extension definition management unit 130, determines the conversion which should be applied or the automatic execution process, and instructs the conversion execution section 115 or the browser control unit 120 to perform it.

When the conversion execution section 115 receives the execution instruction, it executes the specified conversion definition 133 of the extension definition management unit 130, changes the request message or the response message stored in the message storage section 112, and sends a transmission instruction to the communication processing section 111.

When the communication processing section 111 receives the transmission instruction, it transmits the message which has already been changed and is recorded in the message storage section 112 to the Web browser 103 or the web application 105.

When the browser control unit 120 receives the execution instruction, it executes the specified automatic execution definition 134 of the extension definition management unit 130 and sends a control event corresponding to a user's GUI to the Web browser 103.

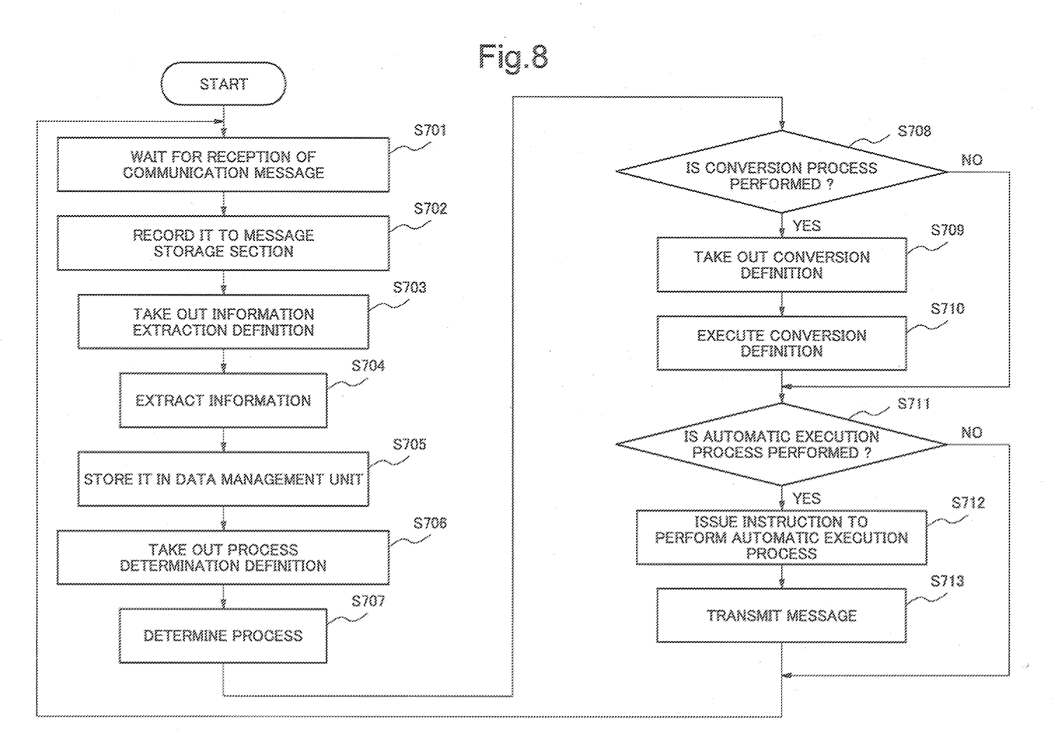

FIG. 8 shows a flow of the operation of the application extension system 101 according to the exemplary embodiment.

The application extension system 101 waits for a reception of the communication message first (step S701) and when the communication processing section 111 receives the message, the communication processing section 111 records the message to the message storage section 112 (step S702).

Next, the information extraction section 113 takes out the information extraction definition 131 from the extension definition management unit 130 (step S703), extracts information from the message according to the information extraction definition 131 (step S704), and stores the extracted information in the data management unit 140 (step S705).

Next, the process determination section 114 takes out the process decision definition 132 from the extension definition management unit 130 (step S706) and determines a process which should be applied by referring to the data of the data management unit 140 according to the process decision definition 132 (step S707). Next, when the conversion process is determined (step S708/Yes), the conversion execution section 115 takes out the specified conversion definition 133 from the extension definition management unit 130 (step S709), executes the conversion definition 133, and changes the message recorded to the message storage section 112 by referring to the data of the data management unit 140 when needed (step S710). When there is no conversion process which should be applied (step S708/No), all the conversion definitions are not executed.

Next, when the automatic execution process is determined (step S711/Yes), the process determination section 114 instructs the browser control unit 120 to execute the determined automatic execution definition 134 (step S712).

Finally, the communication processing section 111 transmits the message recorded in the message storage section 112 to the Web browser 103 or the web application 105 (step S713). After that, the process returns to the step S701.

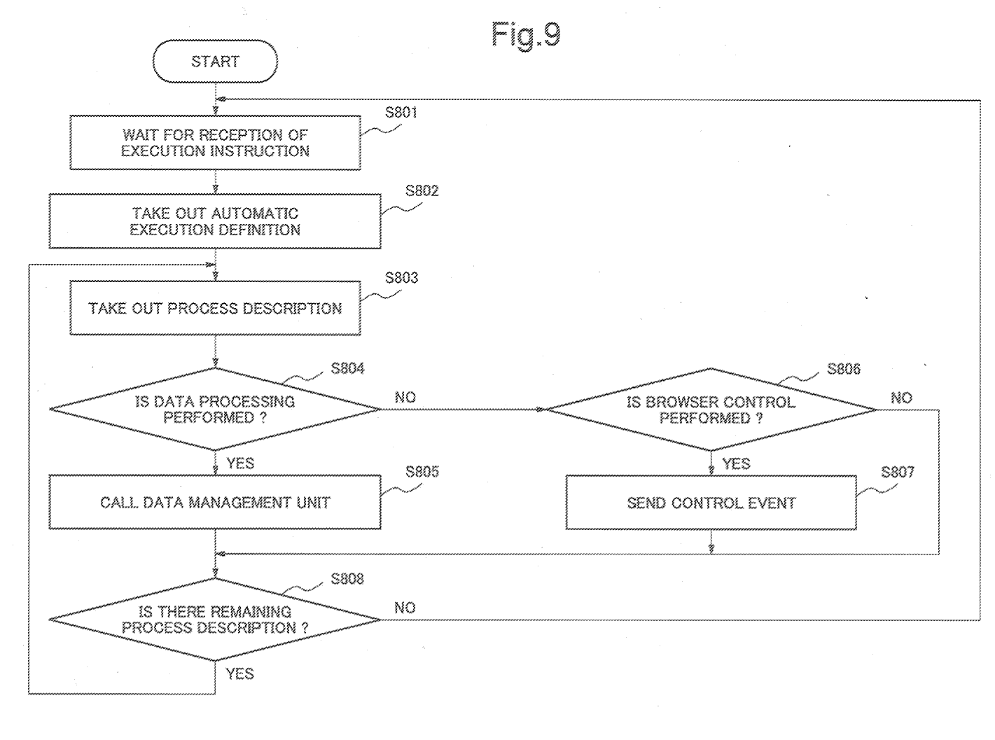

FIG. 9 shows a flow of the operation of the browser control unit 120.

When the browser control unit 120 receives the execution instruction (step S801), it takes out the specified automatic execution definition 134 from the extension definition management unit 130 (step S802). The browser control unit 120 takes out the process description which should be executed next from the automatic execution definition 134 (step S803). When a data processing of the data management unit 140 is described as the process description (step S804/Yes), the browser control unit 120 calls the data management unit 140, refers to the data, and accumulates the data (step S805). When the browser control is described as the process description (step S804/No and S806/Yes), the browser control unit 120 sends the control event corresponding to the specified user GUI operation such as an input of data, a click of a button, or the like to the Web browser 103 (step S807). When there is a further process description which should be executed (step S808/Yes), the process returns to the step S803 to repeat the process.

The automatic execution by the browser control unit 120 and the message process by the proxy unit 110 are performed concurrently and when the next message is sent to the proxy unit 110 in the process of the automatic execution by the browser control unit 120, the process after step S701 is applied to this message.

Thus, the application extension system 1 according to the exemplary embodiment includes the proxy unit 110 for controlling communication of the HTTP, the browser control unit 120 for automatically carrying out the GUI operation of the web application 105 by the Web browser 103, and the data management unit 140 for managing the data shared between the different pages or between the applications. The proxy unit 110 extracts the required information from the request message and the response message, stores it in the data management unit 140, and determines a content of the process which should be performed from the content of the data management unit 140. The content of the process is the conversion of the request message or the response message and the start of the automatic execution.

When the transition to a different page or an emulation of the user operation is needed as the content of the customization to the original web application, the browser control unit 120 is instructed to perform the automatic execution.

When a rewrite is needed in the page as the content of the customization to the original Web browser, the proxy unit 110 issues an instruction of the conversion process.

When the information included in another page is utilized for the determination of the process content, the conversion process, and the automatic execution process, by obtaining the information from the data management unit 140, the proxy unit 110 performs the extension that uses the information over a plurality of pages.

By using such configuration, the customization over a plurality of pages in which a content of one page is used for the conversion of the other page or a user operation procedure over a plurality of screens is changed in the Web page using a screen transition over a plurality of Web pages and a change of the customization method in accordance with the content of the Web page can be performed.

This is because, first, the proxy unit 110 extracts information from the Web page and stores it in the data management unit 140 and the process decision section 132 determines the customization method by using the information extracted from the same page or a different page stored in the data management unit 140 and instructs the conversion execution section 115 or the browser control unit 120 to perform the determination content. The reason is that the conversion execution section 115 performs the conversion process by using the information included in the same page or the different page stored in the data management unit 140 and the browser control unit 120 can start the automatic execution on the Web browser 103 used by the user and perform the screen transition to another page by the instruction from the proxy unit 110.

The application extension system according to the exemplary embodiment can be applied to a use in which the customization is realized by changing the behavior of the application over a plurality of pages without changing the existing application or the user requests that are different from each other are dealt with by one application.

### Second Exemplary Embodiment

A second exemplary embodiment in which the present invention is preferably employed will be described.

In the above-mentioned first exemplary embodiment, although the data management unit 140 simply stores the instructed data, in this exemplary embodiment, this data is managed by associating the data with any session that is managed the Web browser 103 and the communication relay device 102 or between the plurality of the web application 105. This session is a structure which is usually and widely used in the Web system and used for dealing with a plurality of the HTTP requests or responses created by a series of operations as one block. There are various units for dealing with the block, for example, for each terminal device, for each user, a time during which a login is effectively performed when a login process is performed in the proxy unit 110, or the like. There are many methods for realizing the session. However, it is not limited to the specific method. As a preferred example of a session management, a method in which a session ID is recorded by using a cookie of the HTTP and this ID is added to the message is presented.

In the exemplary embodiment, when the communication processing section 111 identifies the session at the time of receiving the message, it records the message together with the session ID for uniquely identifying the session in the communication relay device 102 to the message storage section 112 and the data management unit 140 separately stores the data to be stored for each session ID. When the information extraction section 113, the process determination section 114, and the browser control unit 120 operate for a process of a certain message reception, an operation (reading, rewriting, or the like) is performed with respect to only the data in which the session IDs of the received messages are the same as each other.

When the end of the session (log-out, disconnection of connection with the browser, time-out, or the like) is detected by the communication processing section 111 in any method, the data management unit 140 may discard the data of the session.

When the data of the data management unit 140 is managed by associating the data with the session, the data used for the determination of the process, the conversion, the automatic execution, or the like can be treated as a temporary data that is valid only in a series of specific processes of a specific user.

### Third Exemplary Embodiment

A third exemplary embodiment in which the present invention is preferably employed will be described.

In the above-mentioned second exemplary embodiment, although the data management unit 140 treats all the data as the temporary data associated with the session. However, in this exemplary embodiment, the data can be selected as either the temporary data or the permanent data not depending on the session for each data. Further, when the data is selected as the permanent data, a share range or the like may be set. There are various forms of the share range, for example, sharing among all the communications, sharing among all the sessions of the same user, sharing among the users that include a specific user attribute, or the like.

When the share range can be made designated in any management unit such as the user, the user attribute, or the like, the communication processing section 111 has to include information about the management unit such as a user management function, an authentication function, or the like and be able to acquire information on the management unit such as the user to which the message belongs or the like.

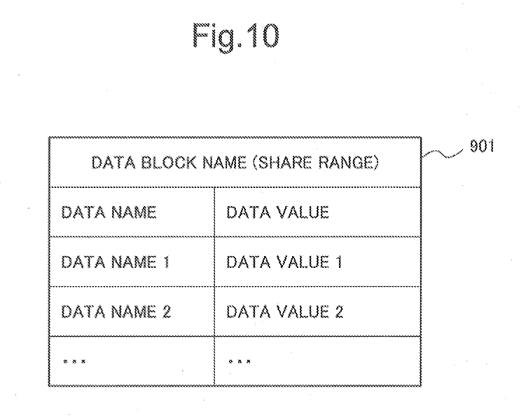

FIG. 10 shows a structure of data managed by the data management unit 140 of the exemplary embodiment. In the exemplary embodiment, the data management unit 140 includes an item of the share range for each data block. If the item of the share range is “temporary”, the data is managed by associating it with the session like the second exemplary embodiment and if the share range is permanent, all the sessions process the same data. When the item of the share range is “permanent” and the share range between the users or the like is further set, the data is separately managed for each share range.

Various information required for the determination of the process and the execution can be flexibly managed by making the temporary data and the shared data be managed together.

### Fourth Exemplary Embodiment

A fourth exemplary embodiment in which the present invention is preferably employed will be described.

In the above-mentioned first exemplary embodiment, the browser control unit 120 is arranged on the terminal device 104 beforehand. However, in this exemplary embodiment, the browser control unit 1.20 is installed as a script executed on the Web browser 103 and when the process determination section 114 determines the automatic execution, the conversion execution section 115 inserts the browser control unit 120 in the response message. A name and a content of the automatic execution definition 134 that should be started are inserted simultaneously or obtained by communicating with the communication relay device 102 after the browser control unit 120 starts the execution on the Web browser 103.

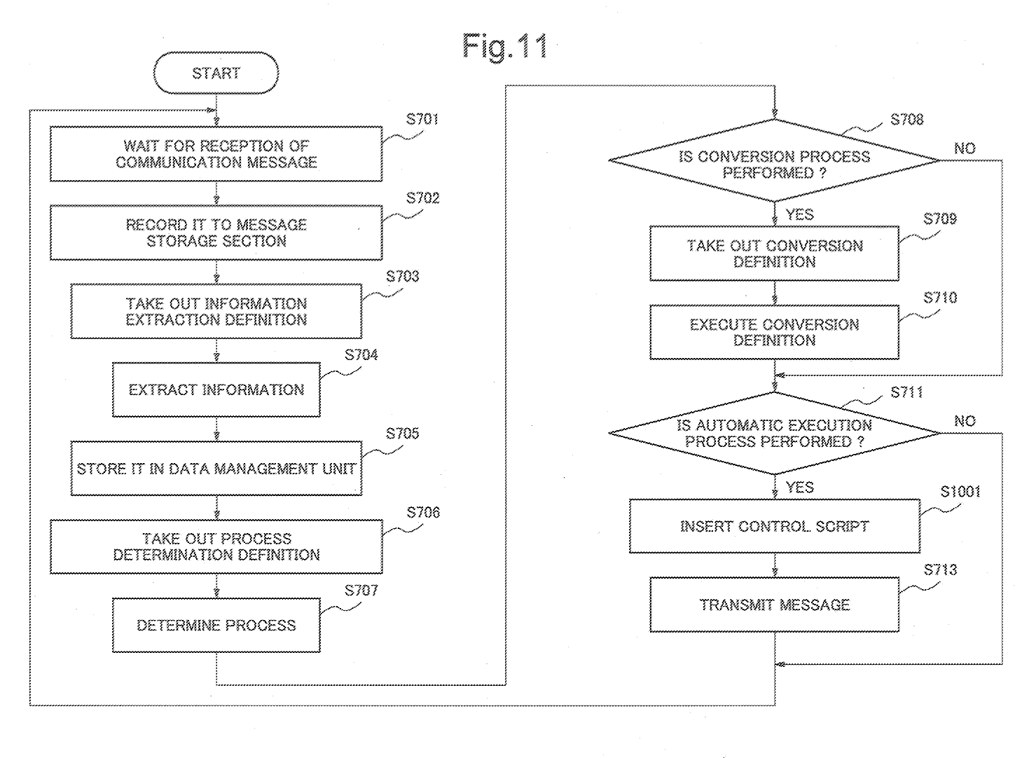

FIG. 11 shows a flow of the operation of the application extension system according to the exemplary embodiment. In FIG. 11, the operation of the step S712 of the flowchart shown in FIG. 8 is replaced with the operation of the step S1001. In the exemplary embodiment, when the process determination section 114 determines the automatic execution (step S711/Yes), it instructs the conversion execution section 115 to perform the automatic execution. The conversion execution section 115 performs the automatic execution and also performs a process for inserting the script of the browser control unit 120 in the response message when it receives the instruction of the automatic execution (Step S1001). The operations other than this operation are the same as the operations shown in FIG. 8.

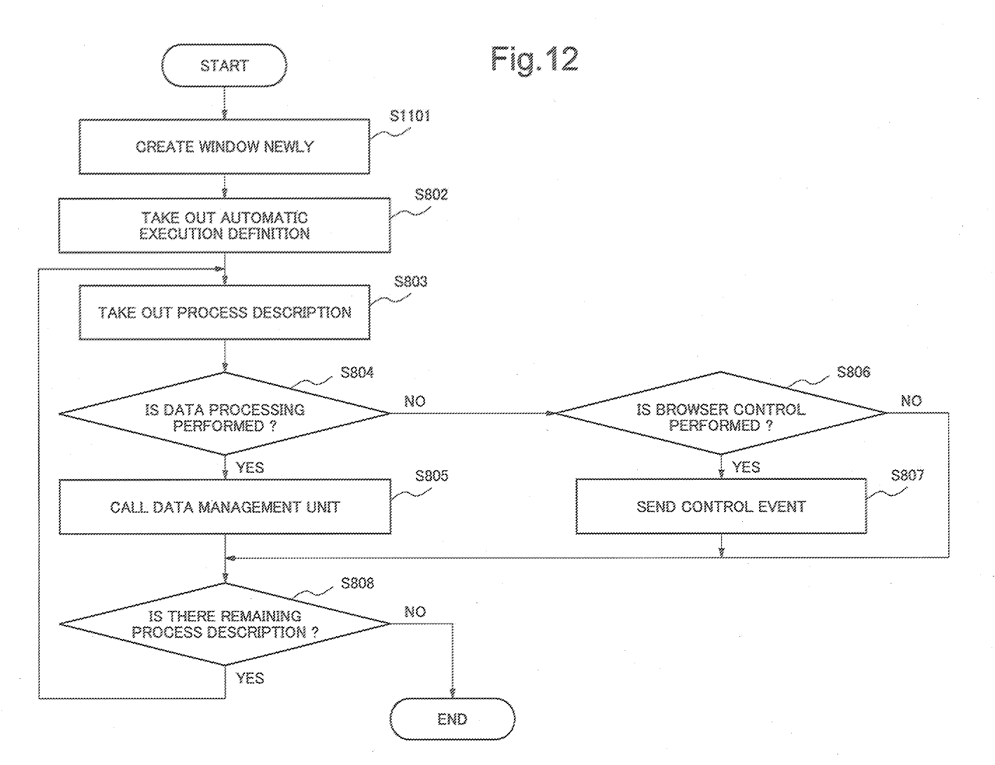

FIG. 12 shows a flow of the operation of the browser control unit 120 according to the exemplary embodiment. The script of the browser control unit 120 first creates a window different from the window displaying the GUI of the web application 105 and executes the script in the created window to perform the operation as the browser control unit 120 (step S1101). The processes after this process are the same as the processes after the step S802 of FIG. 9.

The communication relay device 102 inserts the browser control unit 120 and whereby the application extension system can be realized at a terminal device 104 side by using only a general-purpose browser without preliminary preparation.

Usually, the execution of the script executed in the Web browser stops when the screen transition occurs. However, by creating another window and making it to perform the execution of the browser control unit 120, the function as the browser control unit 120 can continue even when the screen transition of the window displaying the GUI of the original web application 105 has occurred.

### Fifth Exemplary Embodiment

A fifth exemplary embodiment in which the present invention is preferably employed will be described.

In the above-mentioned first exemplary embodiment, the browser control unit 120 is arranged on the terminal device 104. However, the browser control unit may be arranged in the communication relay device 102 and the control event from the browser control unit to the Web browser 103 may be transmitted by communication. There are various communication methods. A preferred example is a remote process calling by a remote procedure call.

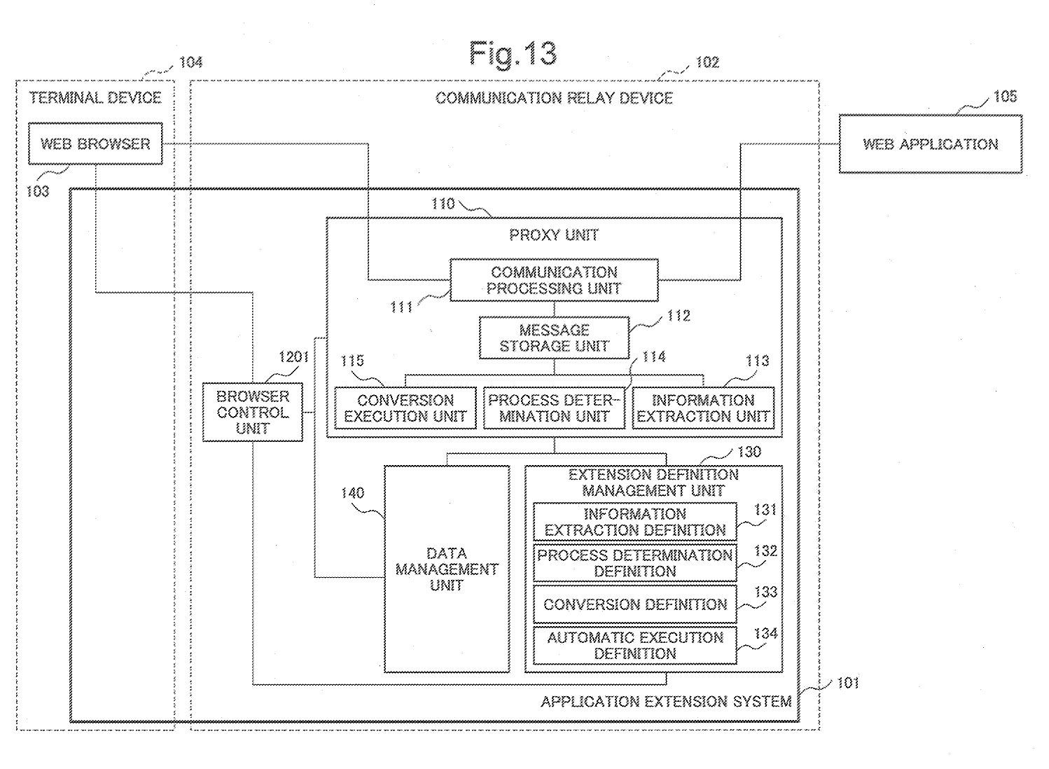

FIG. 13 shows a configuration of the application extension system according to the exemplary embodiment. In the exemplary embodiment, a browser control unit 1201 is arranged on the communication relay device 102. This is a different point from the first exemplary embodiment.

Possibility of remote control of such Web browser 103 depends on a structure of the OS or the like of the Web browser 103 or the terminal device 104. However, the remote control function itself is a widely used and common technology. If the environment is one in which it can be used, by applying the configuration of this exemplary embodiment, the application extension system can be realized at the terminal device 104 side by using only the general-purpose Web browser 103 without preliminary preparation.

### Sixth Exemplary Embodiment

A sixth exemplary embodiment in which the present invention is preferably employed will be described.

In the above-mentioned first exemplary embodiment, the conversion execution section 115 is arranged on the communication relay device 102. However, the conversion execution section may be arranged on the terminal device 104 and after the Web browser 103 displays the page, the screen may be rewritten.

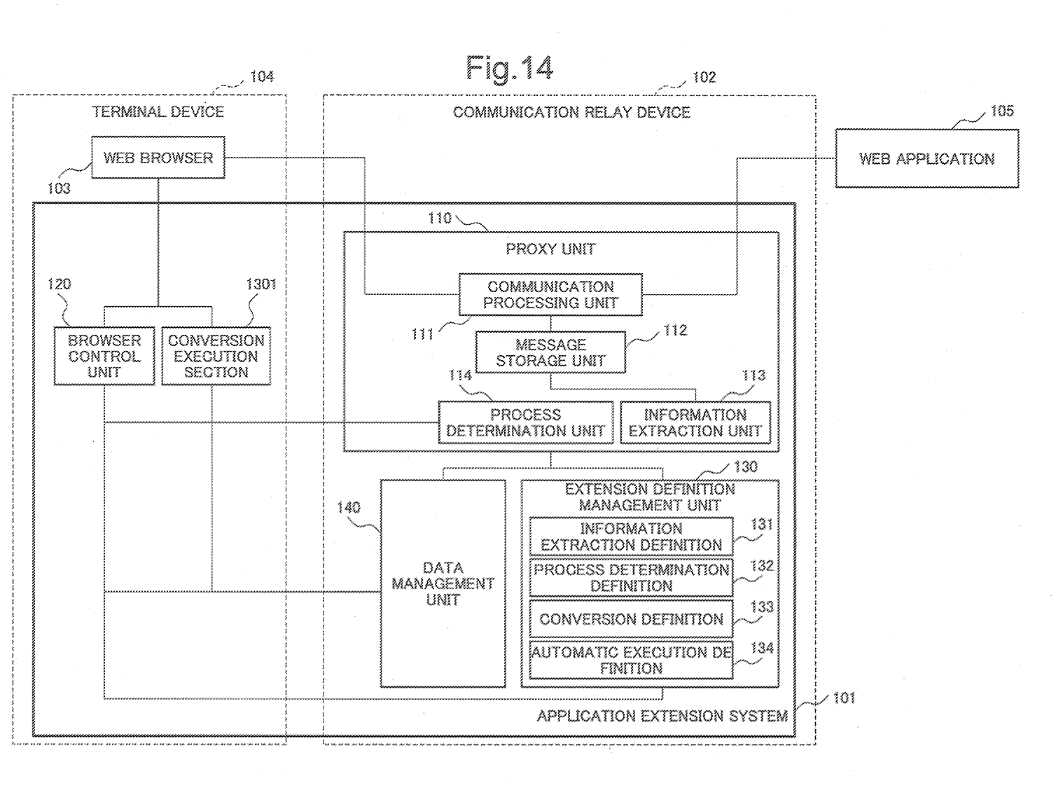

FIG. 14 shows a configuration of the application extension system according to this exemplary embodiment. A conversion execution section 1301 is arranged on the terminal device 104. The conversion process is not performed to the communication message including the HTML or the like and performed to the screen of the result of the interpretation and execution performed by the Web browser 103.

In the web application 105 which dynamically creates a display content on the Web browser 103 by executing the script in the Web browser 103, there is a case in which the content of the screen which should be converted is not included in the response message as the HTML. However, in the exemplary embodiment, the screen conversion of such web application can be realized.

### Seventh Exemplary Embodiment

A seventh exemplary embodiment in which the present invention is preferably employed will be described.

In the above-mentioned first exemplary embodiment, all the definitions are always evaluated with respect to the information extraction definition 131. However, in this exemplary embodiment, the information extraction definition includes a start condition in which the HTTP header, the data of the data management unit 140, or the like is used and the information extraction section 113 evaluates only the extraction formula which satisfies the start condition.

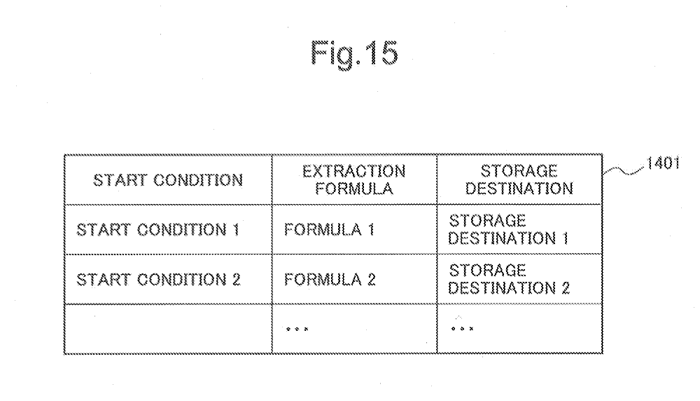

FIG. 15 shows a structure of the information extraction definition 131 of the application extension system according to the exemplary embodiment.

In information extraction from the post data of the request message or the HTML data of the response message, there is a case in which data that is a target of the extraction formula does not exist or there is a possibility of which the data that is not originally intended is extracted because existence or non existence and the content of the HTML of the post data vary greatly depending on the message. The extraction formula can be applied to only the intended message by specifying the start condition like this exemplary embodiment.

Hereinafter, an example of the application extension system according to the preferred exemplary embodiment of the present invention will be described.

### EXAMPLE 1

[Configuration]

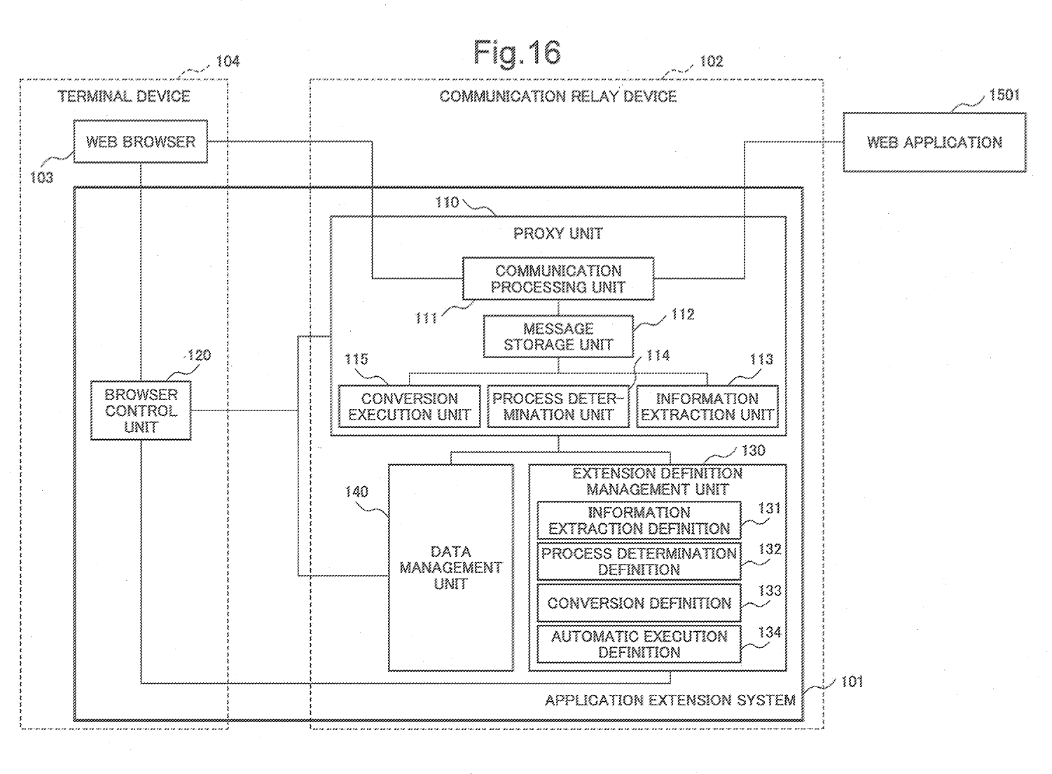

As shown in FIG. 16, the proxy unit 110, the data management unit 140, and the extension definition management unit 130 are arranged on the communication relay device 102 and the browser control unit 120 connected to the Web browser 103 is arranged in the terminal device 104.

The communication processing section 111 of the proxy unit 110 is connected to the Web browser 103 and a web application 1501.

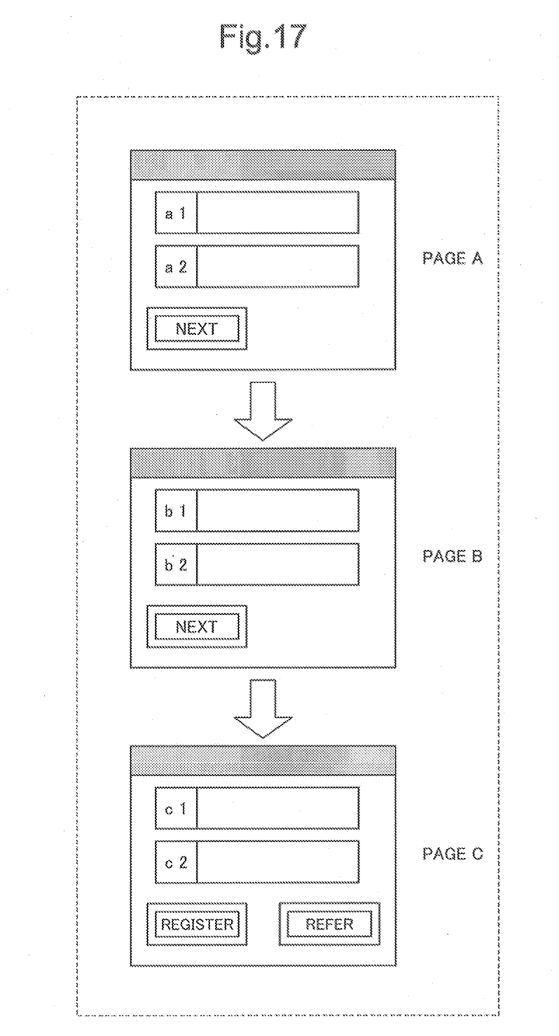

FIG. 17 is a figure showing the operation of the Web application 1501.

The web application 1501 is an application to input information a1, a2, b1, b2, c1 and c2 over three pages: a page A, a page B, and a page C and when a “Next” button is pressed down after the input of the data, a page is moved to the next page. When a “Register” button is pressed down in the page C, the input data is stored in the application.

All the pages of the web application 1501 can be accessed by the same URL and a content of the Web page that is returned with the response message is changed based on the state of the previous communication in the application.

Here, it is assumed that the web application 1501 is customized so as to delete the several input fields in order to simplify a user's input work.

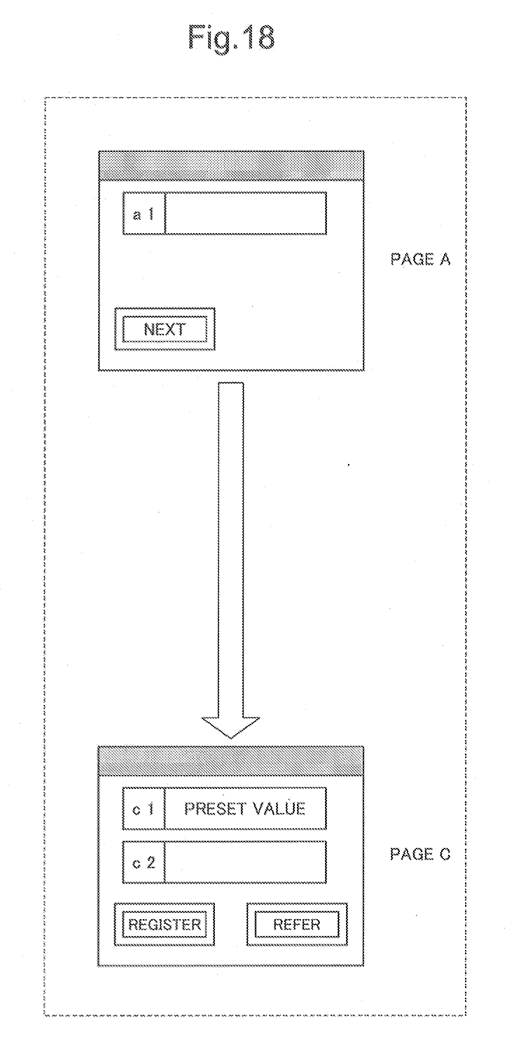

FIG. 18 shows the operation of the web application 1501 which is customized so as to satisfy the user's desire.

Because the information a2, b1, and b2 are the fixed values that do not change, the input of the information is omitted. Only the information a1, c1, and c2 are inputted. Because the information c1 is not a completely fixed value but has the same value in many cases, a predetermined value is set and the value can be changed only when needed.

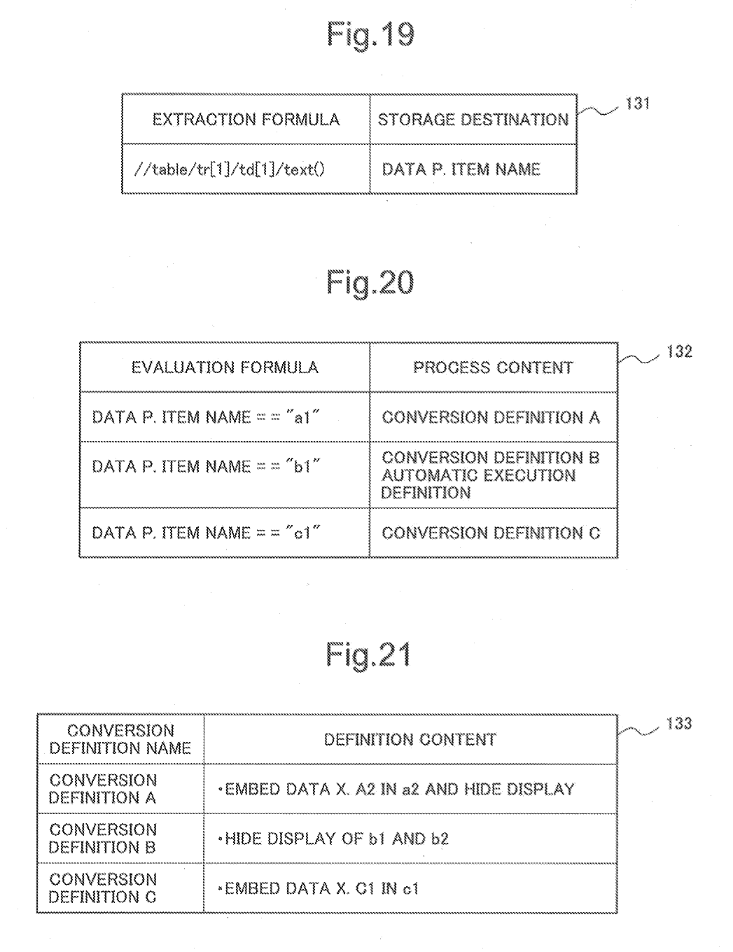

FIG. 19 shows the information extraction definition 131 registered in the extension definition management unit 130. As the extraction formula, the XPath formula “//table/tr[1]/td[1]” for taking out an item name (character string a1, b1, c1, or the like) of a first input field in the page is specified and the extracted content is stored in “item name” of data P as a storage destination.

FIG. 20 shows the process decision definition 132 registered in the extension definition management unit 130. It is distinguished by a value of the “item name” of the data P whether the content of the page is the content of the page A, the content of the page B, or the content of the page C and if it is the content of the page A or the page C, either the conversion definition A or C is executed and if it is the content of the page B, the conversion definition B and the automatic execution definition B are executed.

FIG. 21 shows the conversion definition 133 registered in the extension definition management unit 130.

In the conversion definition A, the conversion is performed so that a value of a data name “a2” of data X is inserted in the input field of a2 and the display of the character string of a2 and the input field is hidden.

In the conversion definition B, the conversion is performed so that the display of the character strings b1 and b2 and the input field is hidden.

In the conversion definition C, the conversion is performed so that a value of a data name “c1” of the data X is inserted in the input field of c1.

Further, when the display is hidden, the display on the Web browser 103 is not performed but the data which is input from the Web browser control unit 120 can perform the operation is in a state in which it is transmitted to the server.

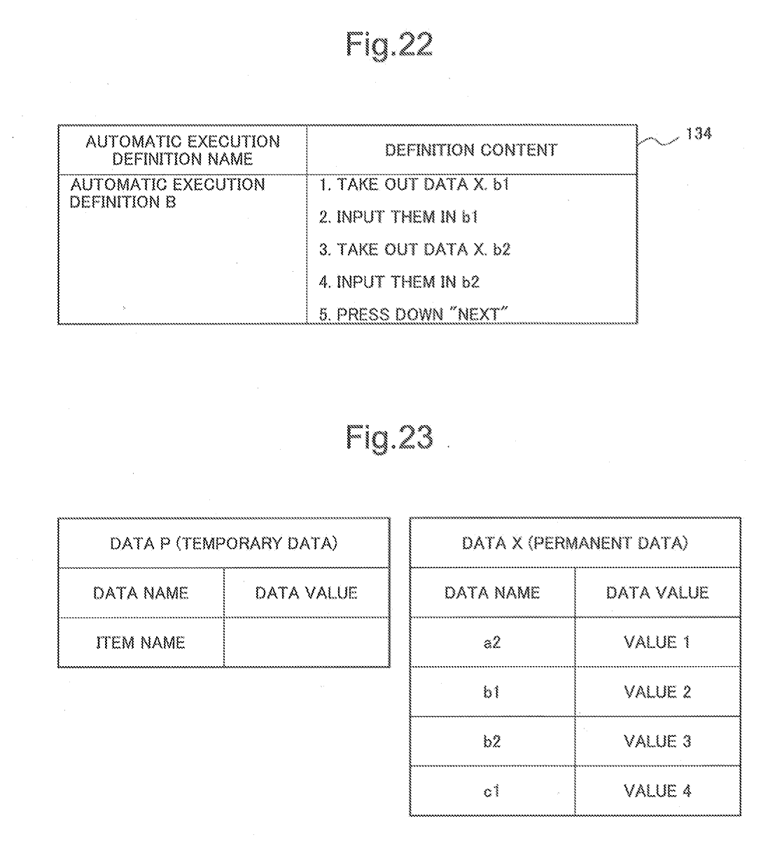

FIG. 22 shows the automatic execution definition 134 registered in the extension definition management unit 130. The automatic execution definition B includes five process descriptions: two of taking-out the data, two of setting to the input field, and pressing down the button.

FIG. 23 shows the data managed by the data management unit 140. There are two data: the data P that is the temporary data which data of the “item name” has and the data X that is the permanent data which has the data of “a2”, “b1”, “b2”, and “c1”.

[Operation]

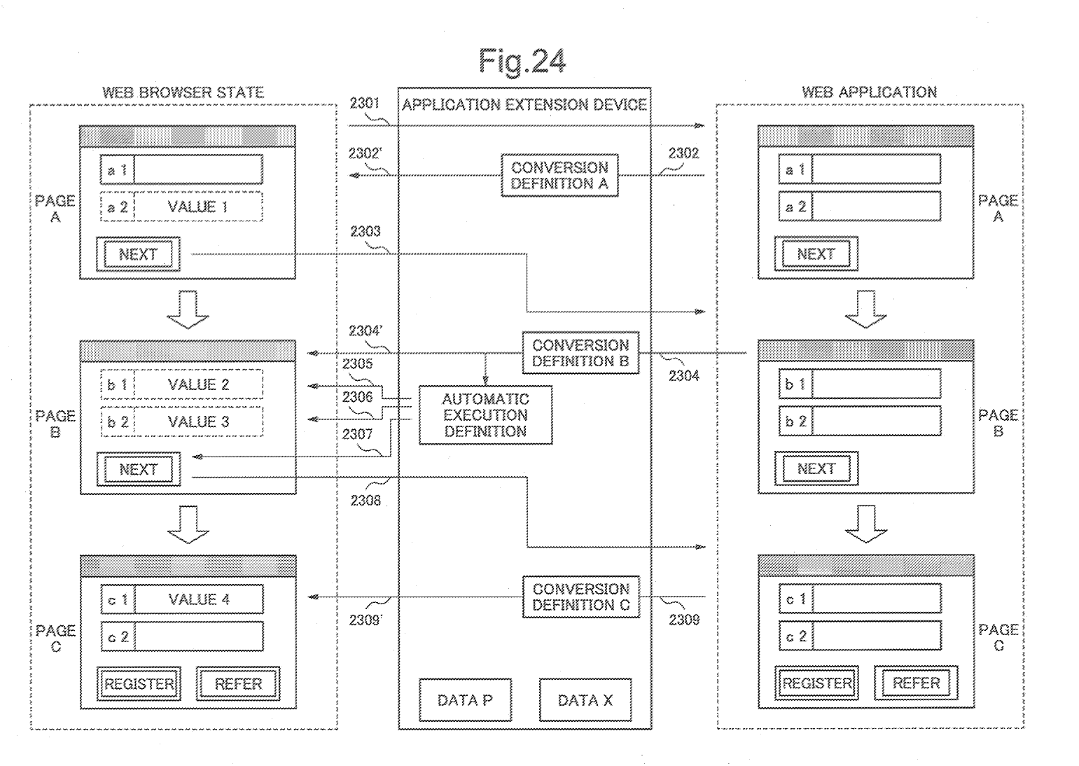

The operation of the application extension system will be described. FIG. 24 shows an example of the operation of the application extension system. When the user sends an access request to the web application 1501 from the Web browser 103 via the communication processing section 111 of the application extension system 101 (2301), the communication processing section 111 records the request message to the message storage section 112 and the information extraction section 113 tries to extract the information. Here, the extraction formula is applied to only the HTML document of the response message. Therefore, in case of the request message, the value of the item name of the data P is an empty character string.

Next, the process determination section 114 evaluates three evaluation formulas of the process decision definition 132. Because no evaluation formula exists now, it is determined that no process is performed and the communication processing section 111 transmits the received request message to the web application 1501.

Further, because no process is performed to the request message, the description of the process for the request message to the page B and the page C is omitted below.

Next, when the web application 1501 receives the request message, it transmits the HTML of the page A as the response message because it is a first communication and this is sent to the communication processing section 111 (2302).

The communication processing section 111 records the response message to the message storage section 112 and the information extraction section 113 tries to extract the information, takes out the character string “a1” as the item name of the first input field in the page, and stores it in the data value of the “item name” of the data P.

Next, the process determination section 114 evaluates three evaluation formulas of the process decision definition 132. Because the formula in a first line satisfies the condition, the process determination section 114 determines the execution of the conversion definition A based on the process content and instructs the conversion execution section 115 to execute the conversion definition A.

The conversion execution section 115 takes out the conversion definition A from the extension definition management unit 130, executes the content of the definition, takes out a “value 1” that is a value of the data name a2 of the data X, sets it as an initial value of the input field of a2, and at the same time, changes the HTML of the response message of the message storage section 112 so that the display of a2 and the input field cannot be viewed.

When the conversion ends, the communication processing section 111 transmits the changed response message to the Web browser 103 (2302′).

The Web browser 103 displays the received page A but the input field of a2 is not displayed here.

Next, when the user inputs a value to a1 and presses down the “Next” button (2303), a second request message is sent to the web application 1501 via the application extension system, and the web application 1501 transmits the content of the page B as the response message (2304).

The communication processing section 111 records the response message to the message storage section 112 and the information extraction section 113 tries to extract the information, takes out the character string “b1” as the item name of the first input field in the page, and stores it in the value of the item name of the data P.

Next, the process determination section 114 evaluates three evaluation formulas of the process decision definition 132. Because the formula in a second line satisfies the condition, the process determination section 114 determines the execution of the conversion definition B and the automatic execution definition B based on the process content, instructs the conversion execution section 115 to execute the conversion definition B, and instructs the browser control unit 120 to execute the automatic execution definition B.

The conversion execution section 115 takes out the conversion definition B from the extension definition management unit 130 and changes the HTML of the response message of the message storage section 112 so that the display of b1 and b2 and the input field cannot be viewed, and the communication processing section 111 transmits the changed response message to the Web browser 103 (2304′).

At the same time, the browser control unit 120 takes out the definition content of the automatic execution definition B from the extension definition management unit 130, performs the process description in order, takes out the value from the data X, b1 and the data X, b2 as the data processing at the first line and the third line, and sends a control event for an input to the input fields of b1 and b2 and a pressing down of the “Next” button to the browser at the second, fourth, and fifth lines (2305, 2306, and 2307).

By this automatic execution, the following request message is sent to the web application 1501.

As a result, only the “Next” button is displayed in the page B in the Web browser 103 and it appears that the screen is automatically moved to the next screen.

Next, a third request message is sent to the web application 1501 like the first and second request messages (2308) and the content of the page C is transmitted as the response message (2309).

The communication processing section 111 records the response message to the message storage section 112 and the information extraction section 113 tries to extract the information, takes out the character string “c1” as the item name of the first input field in the page, and stores it in the value of the item name of the data P.

Next, the process determination section 114 evaluates three evaluation formulas of the process decision definition 132. Because the formula in a third line satisfies the condition, the process determination section 114 determines the execution of the conversion definition C from the process content and instructs the conversion execution section 115 to execute the conversion definition C. The conversion execution section 115 takes out the conversion definition C, executes it, takes out data X. c1, sets the initial value to the input field of c1, and transmits it to the Web browser 103 (2309′).

As a result, the user can use the web application 1501 in a form in which as if a part of page transition is omitted as shown in FIG. 18.

An execution state of an inside of the web application 1501 and the execution state of the Web browser 103 such as a creation of a cookie and a window are the same as those in a case of a direct use without using the application extension system. Therefore, even when the web application 1501 includes a plurality of pages other than the pages A, B, and C and the operation thereof depends on these execution states, the use of the other page can be continued even after the customization is performed.

The share range of the data X that is permanent data is not particularly specified here. However, if the share range of this permanent data is determined for example, for each division to which a user belongs, a value of the fixed value that is automatically inputted for each division can be easily changed.

### EXAMPLE 2

[Configuration]

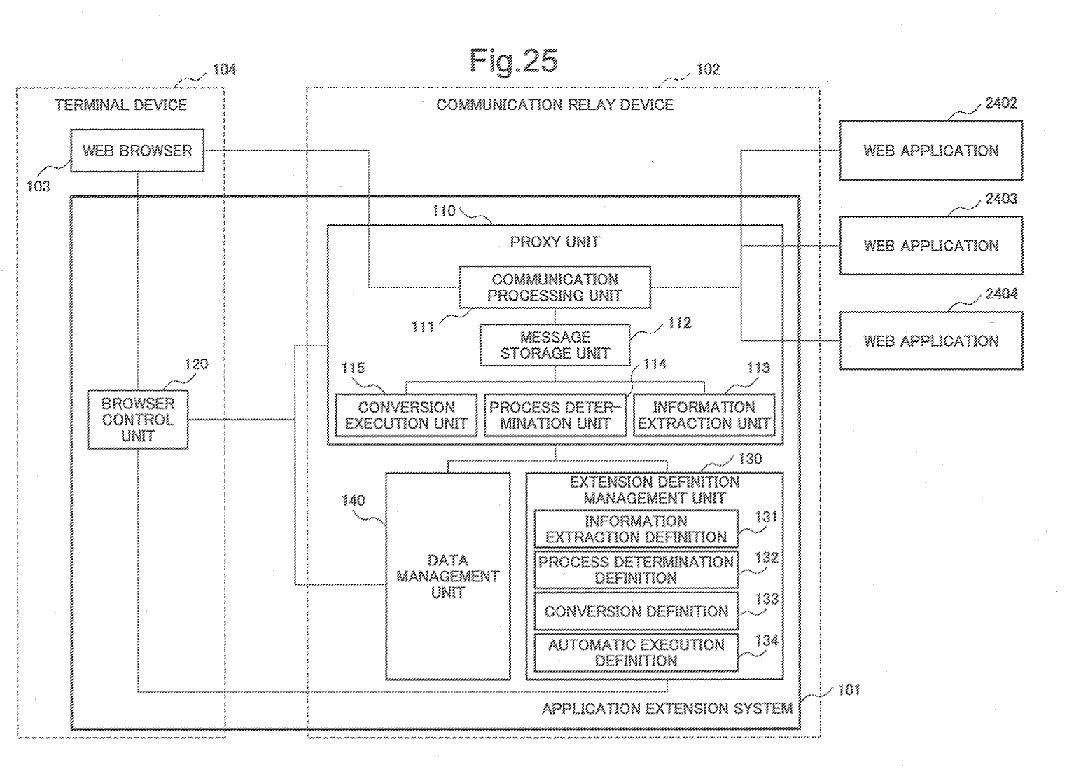

FIG. 25 shows a configuration of the application extension system. The configuration of the example 2 is the same as that of the example 1 excluding the connected Web application and the registered extension definition, the connection. The communication processing section 111 of the proxy unit 110 is connected to Web applications 2402, 2403 and 2404 for the Web application.

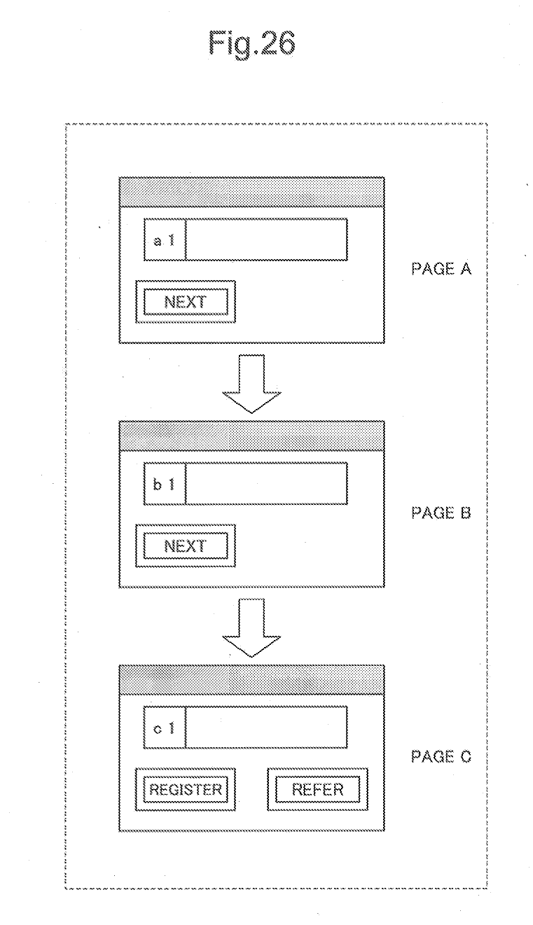

FIG. 26 shows the operation of the Web application 2402. The Web application 2402 inputs information over three pages: the page A, the page B, and the page C like the Web application 1501 but the input items are only a1, b1, and c1.

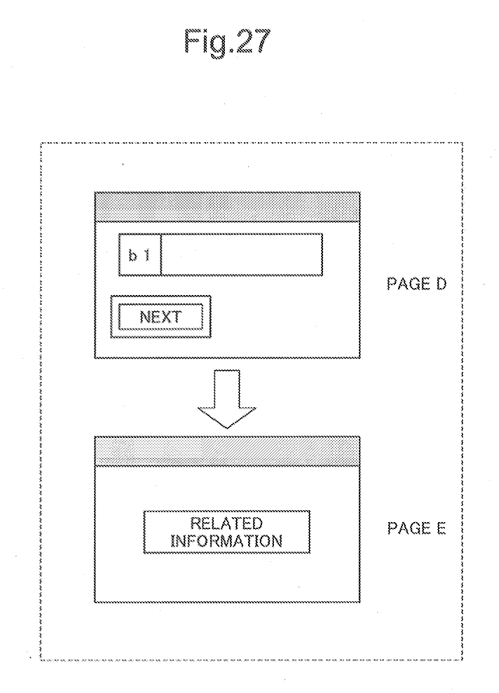

FIG. 27 shows the operation of the Web application 2403: The Web application 2403 includes a page D and a page E. When the entered value of b1 of the Web application 2402 is inputted in the page D, the information related to the entered value is displayed in the page E.

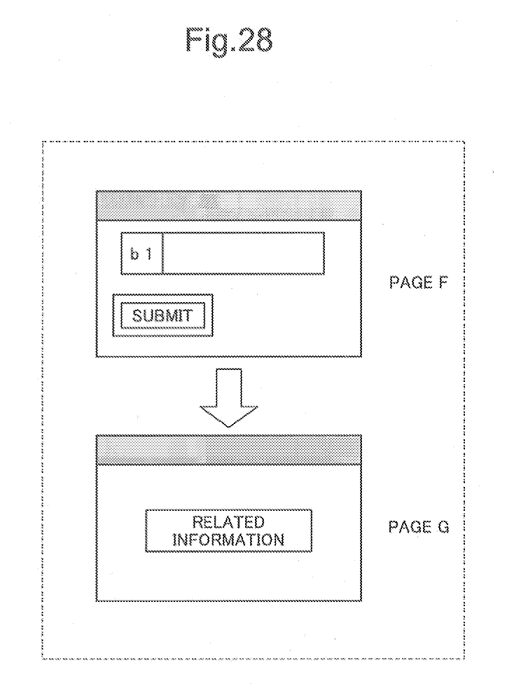

FIG. 28 shows the operation of the Web application 2404. The Web application 2404 includes a page F and a page G. When the value of b1 of the Web application 2402 is inputted in the page F, the information related to the entered value-is displayed in the page G.

Here, it is assumed that the input content of a1 is a customer's business name, the Web application 2403 manages the information on the manufacturing business, and the Web application 2404 manages the information on the other businesses.

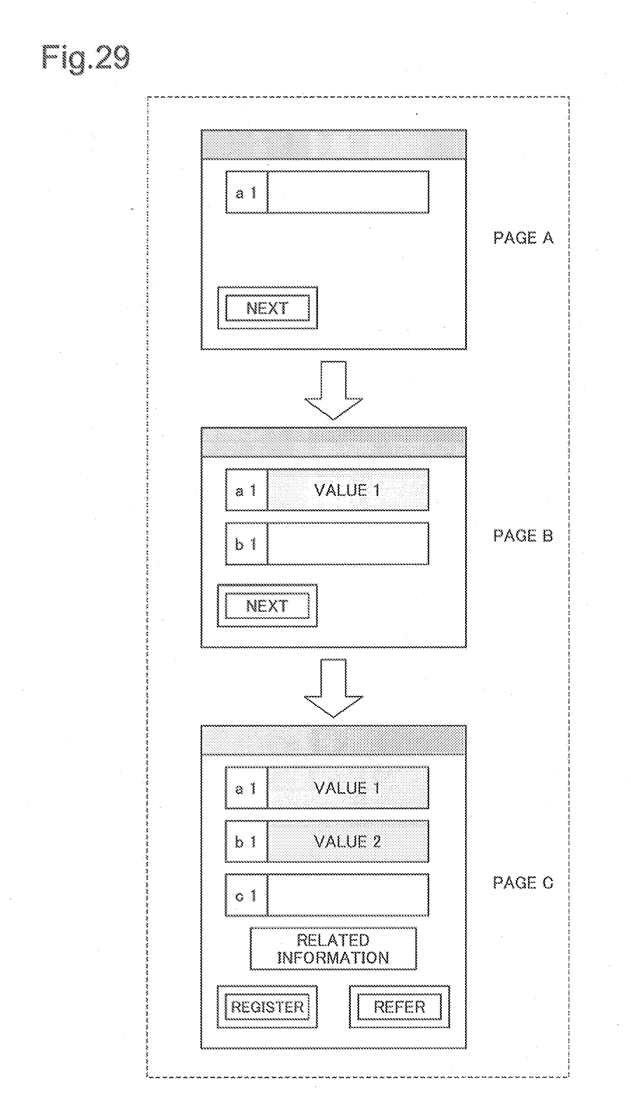

It is assumed that the Web application 2402 is customized so as to add the display of the related information as a reference in order to ease the user's input work as the user's request. FIG. 29 is a figure showing the operation of the Web application 2402 in which the customization has been performed according to the user desire. The display of the page A is not changed. However, the content that has been entered in a previous page is displayed in the pages B and C. Further, a result of a search in which the related information of the value entered in b1 is searched for with the Web application 2403 or 2404 is additionally displayed in the page C.

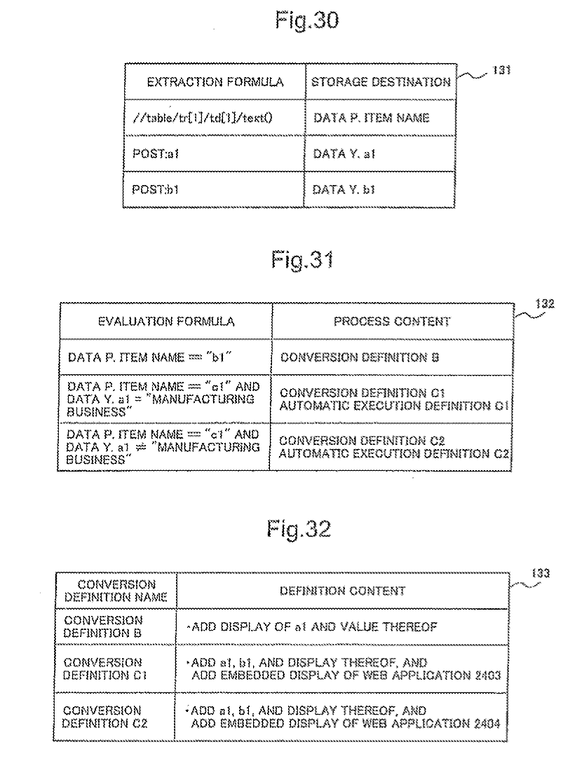

FIG. 30 shows the information extraction definition 131 registered in the extension definition management unit 130. The information extraction definition 131 includes the XPath formula for taking out the item name of the first input field in the page like the example 1 and the “item name” of the storage destination data P and additionally, definitions in which when the request is a POST command of the HTTP, the values of which the names of posted data are a1 and b1 respectively are taken out and stored in a1 or b1 of the data Y, as the extraction formula.

FIG. 31 shows the process decision definition 132 registered in the extension definition management unit 130. It is distinguished by the value of the “item name” of the data P whether the content of the page is the content of the page B or the content of the page C and when it is of the page B, the conversion definition B is executed. When it is of the page C, by referring to the value of a1 of the data Y, if a1 is “manufacturing business”, the conversion definition C1 and the automatic execution definition C1 are executed and if a1 is not “manufacturing business”, the conversion definition C2 and the automatic execution definition C2 are executed.

FIG. 32 shows the conversion definition 133 registered in the extension definition management unit 130.

In the conversion definition B, the display of a1 and the value thereof are added.

In the conversion definition C1, the display of the value of a1 and b1 is added and additionally, an embedded display of the Web application 2403 is added.

In the conversion definition C2, the display of the value of a1 and b1 is added and additionally, the embedded display of the Web application 2404 is added.

Further, the embedded display can be described with IFrame of the HTML, or the like.

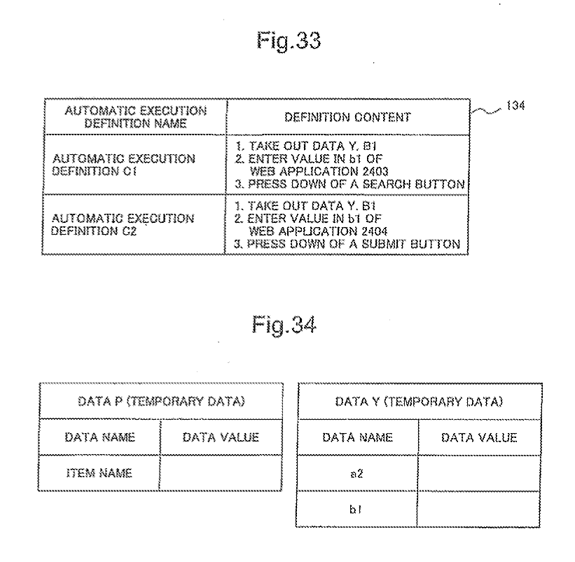

FIG. 33 shows the automatic execution definition 134 registered in the extension definition management unit 130.

The automatic execution definition C1 includes three process descriptions: taking out of the data, setting to the input field, and pressing down of a search button. On the other hand, the automatic execution definition C2 includes three process descriptions: taking out of the data, setting to the input field, and pressing down of a submit button.

FIG. 34 shows data managed by the data management unit 140.

It includes the data P that is the temporary data which has data of “item name” and data Y that is the temporary data which has the data of “a1” and “b1”.

[Operation]

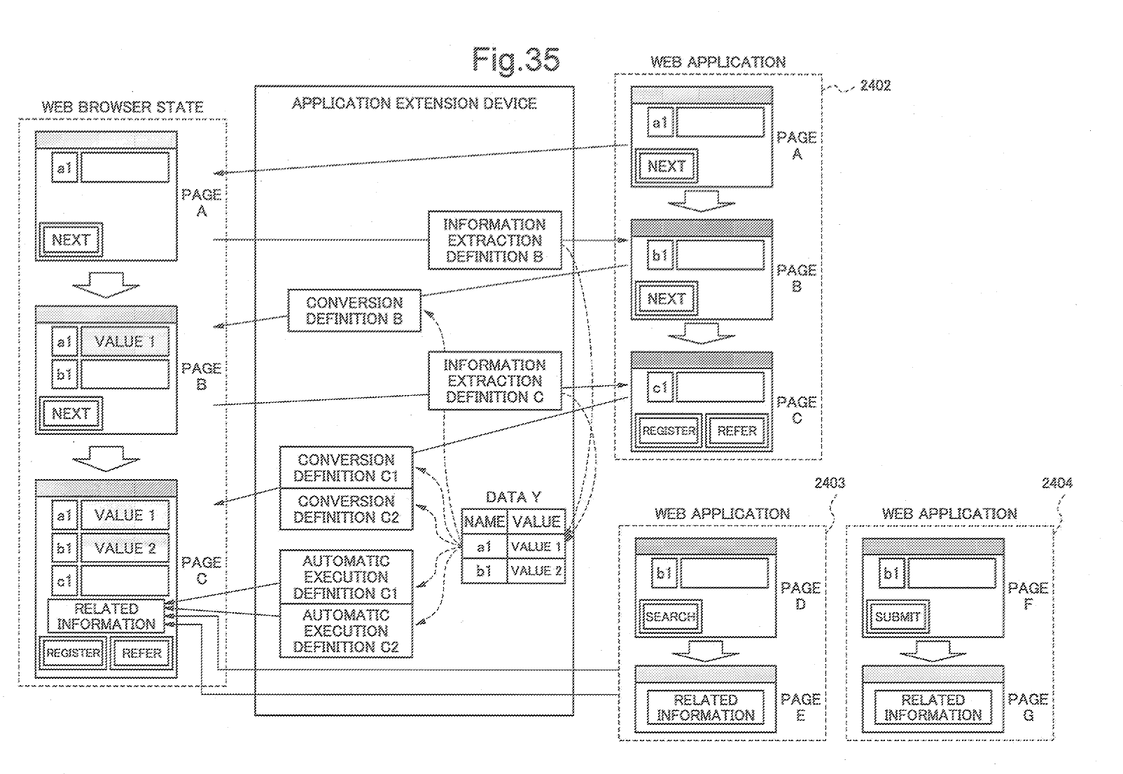

FIG. 35 shows the operation of the application extension system. Further, the operation in which the communication processing section 111 receives the message, records it to the message storage section 112, and lastly, transmits the recorded message is the same as that of the first example. Therefore, the description will be omitted.

Further, the operation in which the item name of the first input field in the page is stored in the data P and it is used for the determination of the pages B and C is also the same as the first example. Therefore, the description will be omitted.

In this example, the information extraction section 113 takes out the entered values of a1 and b1 from the request message sent when the “Next” button of the page A and the page B is pressed down and the values are stored in the data Y.

With respect to the response message of the page B, the conversion definition B is selected and executed by the conversion execution section 115. As the conversion process, the entered value of a1 that is included in the previous request message is taken out from the data Y and embedded in the HTML of the page B.

With respect to the response message of the page C, first, in a step of evaluating the evaluation formula of the process decision definition 132, the entered value of a1 that is included in the previous request message is taken out from the data Y and evaluated. Based on the result of the determination of whether the value is “manufacturing business”, a process to be executed that is one of a process in which the conversion definition C1 and the automatic execution definition C1 are executed and a process in which the conversion definition C2 and the automatic execution definition C2 are executed is determined.

When the entered value of a1 is “manufacturing business”, the conversion definition C1 is executed by the conversion execution section 115, the entered value of a1 and b1 in the previous page is taken out from the data Y, and the display is added. Additionally, the embedded display of the Web application 2403 is added.

Next, the automatic execution definition C1 is executed by the browser control unit 120, the entered value of b1 of the data Y is taken out, it is inserted in the input field of b1 of the Web application 2403 that is embedded and displayed, and the search button is pressed down.

As a result, the page E of the Web application 2403 is embedded and displayed at a part of the related information of the page C.

When the entered value of a1 is not “manufacturing business”, the conversion definition C2 is executed by the conversion execution section 115, the entered value of a1 and b1 in the previous page is taken out from the data Y, and the display is added. Additionally, the embedded display of the Web application 2404 is added.

Next, the automatic execution definition C2 is executed by the browser control unit 120, the entered value of b1 of the data Y is taken out, it is inserted in the input field of b1 of the Web application 2404 that is embedded and displayed, and the submit button is pressed down.

As a result, the page G of the Web application 2404 is embedded at a part of the related information of the page C.

As a result, by referring to the content of the message of the request and the response that has been previously transmitted and received, the content can be additionally displayed and the operation of the customization can be changed in accordance with the content.

The information which cannot be displayed without performing any GUI operation like the page E and the page G can be displayed by a combination with the other application.

By realizing the customization without changing the application, the customization of the behavior of the application can be performed for each user that includes different requests from another user and the display thereof can be performed by arranging a plurality of application extension systems or only changing the extension definition applied for each user

Further, in each of the above-mentioned exemplary embodiments, the Web system which includes the HTTP and the HTML is used as an example. However, a delivery protocol of the message is not limited to the HTTP and further; the content of the message is not limited to the HTML. When a system includes a form in which the browser on a general-purpose terminal acquires data describing a content of the GUI from the application through communication, interprets it, and displays it, and the user operates the GUI displayed in the browser, the present invention can be applied to the system.

Thus, the various modifications of the present invention can be made.

This application claims priority based on Japanese Patent Application No. 2008-170297 filed on Jun. 30, 2008 and the disclosure of which is hereby incorporated in its entirety.

[Description of Symbol]

1, 101 application extension system

11 interface

12 communication interface

13, 132 process decision definition

14, 134 automatic execution definition

15 control unit

20 browser

30 application

102 communication relay device

103 Web browser

104 terminal device

105, 1501, 2402, 2403, 2404 Web application

110 proxy unit

111 communication processing section

112 message storage section

113 information extraction section

114 process determination section

115, 1301 conversion execution section

120, 1201 browser control unit

130 extension definition management unit

131 information extraction definition

133 conversion definition

140 data management unit

1. An application extension system comprising:
an interface which receives registration of a process determination definition including a start condition of an automatic execution and an automatic execution definition which indicates a content of a process performed as the automatic execution; and
a communication interface which receives a communication message from a browser or an application, and
at the time of receiving the communication message from the browser or the application, the application extension system
determining whether to execute the registered automatic execution definition according to the registered process determination definition,
transmitting the communication message to the application or the browser that is a destination, and
sending at least one GUI operation instruction to the browser according to the automatic execution definition for which execution has been determined.

2. The application extension system according to claim 1, comprising:
a proxy unit which controls a communication message between the browser and the application;
a browser control unit for performing the automatic execution of at least one GUI operation of the browser according to the automatic execution definition; and
an extension definition management unit for storing the process determination definition and the automatic execution definition, and
the proxy unit determining a start of the automatic execution according to the process determination definition at the time of receiving the communication message and instructing the browser control unit to start the automatic execution, and
the browser control unit which receiving the instruction to start the automatic execution performs the GUI operation according to the automatic execution definition.

3. The application extension system according to claim 2 wherein
the extension definition management unit further stores a conversion definition for converting the communication message, and
the proxy unit further determines whether to perform the conversion process at the time of determining the process and converts the communication message according to the conversion definition when the conversion process is performed.

4. The application extension system according to claim 3, further comprising a data management unit which holds the data extracted from the communication message,
wherein the extension definition management unit further stores an information extraction definition for extracting information from the communication message,
the proxy unit includes information extraction unit which transfers the information from the communication message according to the information extraction definition at the time of receiving the communication message and storing the obtained data in the data management unit, process determination unit which determines a process by referring to the data of the data management unit at the time of determining the process, and conversion execution unit which performs the conversion process by referring to the data of the data management unit at the time of performing the conversion process, and
the browser control unit performs the automatic execution process by referring to the data of the data management unit.

5. The application extension system according to claim 4 wherein
the proxy unit recognizes session information between the browser and the application at the time of receiving the communication message,
the data management unit manages the data to be held for each session information, and
information extraction unit, the process determination unit, and the conversion execution unit of the proxy unit and the browser control unit perform a reading the data related to the session of the communication message to be processed from the data management unit and use it in the process of each unit.

6. The application extension system according to claim 5 wherein
the data management unit holds the data shared between the different sessions in addition to the data managed for each session and
the proxy unit and the browser control unit use the both kinds of data in the process of each unit.

7. The application extension system according to claims 2 wherein
the application extension system comprises of a terminal device and a communication relay device,
the browser control unit is arranged on the terminal device, and
the proxy unit is arranged on the communication relay device.

8. The application extension system according to claims 2 wherein
the application extension system comprises of a terminal device and a communication relay device, and
the browser control unit and the proxy unit are arranged on the communication relay device.

9. The application extension system according to claims 2 wherein
when the proxy unit determines a start of the automatic execution, the browser control unit is inserted in a response message of communication so that the browser is automatically activated at the time of receiving the response message and the automatic execution is started when the browser control unit is activated by the browser.

10. The application extension system according to claims 3 wherein
the application extension system comprises of a terminal device and a communication relay device and further includes a conversion execution section arranged on the terminal device,
an instruction to execute the conversion process is issued to the conversion execution section when the proxy unit determines the execution of the conversion process, and
the conversion execution section converts a display screen of the result obtained by analyzing and processing the response message by the browser.

11. An application extension method comprising:
receiving registration of a process determination definition including a start condition of an automatic execution and an automatic execution definition which indicates a content of a process performed as the automatic execution;
receiving a communication message from a browser or an application;
determining whether to execute the registered automatic execution definition according to the registered process determination definition;
transmitting the received communication message to the application or the browser that is a destination; and
sending at least one GUI operation instruction to the browser according to the automatic execution definition for which execution has been determined.

12. The application extension method according to claim 11, further comprising:
receiving registration of the conversion definition for converting the communication message,
determining whether to perform a conversion process when it is determined whether to execute the automatic execution definition, and
converting the communication message according to the conversion definition when the conversion process is performed.

13. The application extension method according to claim 12, further comprises:
receiving registration of an information extraction definition for extracting information from the communication message,
storing the data extracted from the communication message according to the information extraction definition at the time of receiving the communication message, and
using the stored data at the time of the determination of whether to execute the automatic execution definition, the conversion process, and the automatic execution process.

14. The application extension method according to claim 13, further comprising:
recognizing session information between the browser and the application at the time of receiving the communication message,
managing the data that is extracted from the communication message and stored for each session information, and
reading out the data related to the session of the communication message to be processed among the stored data and using it to the extraction of the data from the communication message, the determination of whether to execute the automatic execution definition, the conversion process, and the automatic execution process.

15. The application extension method according to claim 14, further comprises:
holding data shared between the different sessions in addition to the data managed for each session and
using the both kinds of data for the extraction of the data from the communication message, the determination of whether to execute the automatic execution definition, the conversion process, and the automatic execution process.

16. A computer readable medium recording thereon embodying an application extension program, enabling a computer to:
receive registration of a process determination definition including a start condition of an automatic execution and an automatic execution definition which indicates a content of a process performed as the automatic execution;
receive a communication message from a browser or an application;
determine whether to execute the registered automatic execution definition according to the registered process determination definition;
transmit the received communication message to the application or the browser that is a destination; and
send at least one GUI operation instruction to the browser according to the automatic execution definition for which execution has been determined.

17. The computer readable medium according to claim 18, said program further enabling a computer to:
receive registration of the conversion definition for converting the communication message,
determine whether to perform a conversion process when it is determined whether to execute the automatic execution definition, and
convert the communication message according to the conversion definition when the conversion process is performed.

18. The computer readable medium according to claim 18, said program further enabling a computer to:
recognize session information between the browser and the application at the time of receiving the communication message,
manage the data that is extracted from the communication message and stored for each session information, and
read out the data related to the session of the communication message to be processed among the stored data and using it to the extraction of the data from the communication message, the determination of whether to execute the automatic execution definition, the conversion process, and the automatic execution process.

19. The computer readable medium according to claim 18, said program further enabling a computer to:
hold data shared between the different sessions in addition to the data managed for each session and
use the both kinds of data for the extraction of the data from the communication message, the determination of whether to execute the automatic execution definition, the conversion process, and the automatic execution process.

20. The computer readable medium according to claim 18, said program further enabling a computer to:
hold data shared between the different sessions in addition to the data managed for each session and
use the both kinds of data for the extraction of the data from the communication message, the determination of whether to execute the automatic execution definition, the conversion process, and the automatic execution process.
